(19) United States
(12) Patent Application Publication
(10) Pub. No.: US 2006/0272025 A1
(43) Pub. Date: Nov. 30, 2006

(54) Processing of packet data in a communication system

(75) Inventor: Risto Mononen, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/441,122

(22) Filed: May 26, 2006

(30) Foreign Application Priority Data
May 26, 2005 (FI) 20050561

(51) Int. Cl. H04N 7/16

(52) U.S. Cl. 726/26

(57) ABSTRACT

Processing of packet data in a communication system supporting at least packet data transfer involves the following. Packet data is received from a source. It is determined, based on the received packet data, whether there is anomalous behaviour of the packet data source. Data transmission resources for a communications device are limited in response to determining anomalous behaviour of the source, and transmission of packet data for the communications device is provided using the limited transmission resources. The communications device is either the source or a destination of at least part of the packet data received from the source. In the communication system, access to a set of services from the communications device may furthermore be blocked.

### BACKGROUND OF THE INVENTION

1. Field of the Invention

The present invention relates in general to processing of packet data in a communication system supporting packet data transfer. The present invention relates in particular to processing of packet data relating to devices infected with malware, malfunctioning devices or devices otherwise subject to anomalous behaviour.

2. Description of Related Art

A communication system can be seen as a facility that enables communication between two or more entities such as user equipment and/or other nodes associated with the system. The communication may comprise, for example, communication of voice, data, multimedia and so on. The communication system may be circuit switched or packet switched. The communication system may be configured to provide wireless communication.

Communication systems able to support mobility of communications devices across a large geographic area are generally called mobile communications system. In cellular communication systems a communications device typically changed the cell via which it communicates. Some examples of a cellular system are the Global System for Mobile Telecommunications (GSM) and General Packet Radio Service (GPRS). GPRS provides packet-switched data services and utilizes the infrastructure of a GSM system. Two further examples of cellular systems are EDGE and EGPRS, which are further enhancements to GSM and GPRS. EDGE refers to Enhanced Data Rates for GSM Evolution, and EGPRS refers to EDGE GPRS.

Viruses are a common problem in personal computers (PCs) that are connected to public data networks. The effects of a virus on a computer may various: the computer may totally crash down, the user may notice some oddities or the user may be unaware of a virus infecting his computer. In any case, the virus typically aims to spread further to network nodes. Some viruses may scan actively network nodes connected to the network. It is also possible that a node affected by a virus causes, by flooding a network or a server, connections to other nodes to be refused or cut off.

There are various types of viruses, worms and other software, which may be resident on a communications device without the user knowing or intentionally installing the software. In the following description a term malware (shortened from malicious software) is used to refer to any software or program which causes traffic without the user of a communications device knowing about the presence of the software.

As it is possible to use a personal computer in, for example, a GPRS network by supplying the computer with suitable equipment (often called a card phone), the traffic caused by viruses affects also cellular networks. Furthermore, it is possible that viruses will spread also to other user equipment than personal computers, such as to personal digital assistants (PDAs) or modern portable telephones.

Especially in the radio access network (in wireless environment) communication resources are limited. Useless traffic caused by viruses may cause serious difficulties, such as latency or loss of packets, for normal traffic. Especially connections, where both end points are reachable via a wireless network, are sensitive to latency and loss of packets. Due to latency and/or loss of packets, transport protocols encounter challenges to keep connections alive.

It would therefore be beneficiary to remove viruses from network nodes and clear virus infected data packets. Some known approaches are static cleaning of the network nodes, packet filtering and firewalls. Static cleaning refers to anti-virus software installed/running on a computer or network node. The anti-virus software typically scans stored files or data and seeks featured character queue to identify known viruses. If anti-virus software finds virus infected file or data, the anti-virus software will clean or quarantine the infected object. The effectiveness of static cleaning depends on how well users of computers or other communication devices use anti-virus software. Firewalls and packet filtering typically look at the network addresses (for example Internet Protocol addresses) and port numbers only, whereas viruses are spreading on the application level. Packet filtering thus typically partly prevents virus infections. However, packet filtering is never perfect, and malware may pass through packet filters and operate in communications devices.

As the user of a communications device may not update the anti-virus software or the communications device may for other reasons contain malware, the operator of a communications system should try to protect the communications system from the effect of malware. One example of the effects of malware is that, due to a waste of transmission resources, users experience degraded quality of service or failures in establishing connections.

In the Third Generation Partnership Project (3GPP) standardization, it has been discussed how to decrease the impact of malware in cellular networks. In S3-040873 proposal “Selective Disabling of UE Capabilities”, disabling of a terminal has been proposed in response to determining that the terminal is infected with malware. Disabling of a terminal refers here to the operator remotely configuring the terminal so that it cannot transmit any packet data over the network.

Disabling of a terminal causes a denial of service threat to users of terminals, because it may be possible to trigger disabling of a terminal to cut off terminals, which are not infected by malware, from the network. Furthermore, users may become irritated by being cut off from the network totally due to a virus or other malware.

A further problem relates to correctly identifying the infected device. If the infected device is not the terminal of the cellular network but, for example, a laptop computer connected to the terminal, disabling the terminal is not a proper solution. The laptop may be connected to a further terminal and continue the transfer of infected packet data. The terminal, on the other hand, should be able to use packet data connectivity once the laptop has been disconnected. Selective disabling of the laptop itself is not typically possible—the mobile network operator does not usually have administrator rights to configure the laptop.

Regarding denial of service attacks, WO0203653 discusses denial of service attacks from the victim's viewpoint. The source of a denial or service attack may be extremely difficult to determine due to the stateless nature of Internet routing. Attackers typically use incorrect or spoofed IP source addresses. WO0203653 proposes a scheme, where it is first analysed whether a terminal is a (probable) victim of a denial of service attack. This occurs typically near the terminal, within the network segment protected by a firewall and separated from the rest of the network with an edge router. If the terminal is a probable victim of a denial of service attack, the source of the attack (attacker) is traced. Data transmitted from the attacker towards the victim of the denial of service attack is filtered in the edge router relating to the network where the attacker is residing. Alternatively, quality of service of the data traffic sent from the attacker and directed towards the victim of the denial of service attack may be reduced.

Some proposals for limiting computer worms from spreading in a computer system are discussed in Section 8 of “Modelling a Computer Worm Defense System” by Senthilkumar Cheetancheri. This Master's Thesis has presented at the University of California, Davis in 2004, and it can be downloaded from http://seclab.cs.ucdavis.edu/papers/Cheetancherithesis.pdf. In Section 8, it is proposed to reduce the bandwidth allocated to general traffic in the computer system and to increase the bandwidth allocated to alert messages between hosts in the computer system, when it has be detected that a worm is propagating in the computer system.

Embodiments of the present invention aim to address at least some of the problems discussed above in connection with disabling a terminal in a cellular communications system. Although the invention is discussed mainly in connection with cellular communication systems, it may be applicable also in other communication systems.

### SUMMARY OF THE INVENTION

A first aspect of the invention provides a method for processing packet data in a communication system supporting at least packet data transfer, the method comprising

determining anomalous behaviour of a source of packet data based on packet data received in a network element,

limiting packet data communication resources provided by the network element for a communications device in response to determining the anomalous behaviour of the source, the communication device being a destination of at least part of the packet data based on which the anomalous behaviour of the source is determined or the communications device being the source, and

providing transmission of packet data for the communications device in the communications system using the limited transmission resources.

A second aspect of the invention provides a communication system supporting at least packet data transfer, comprising

means for receiving packet data,

means for determining anomalous behaviour of a source of packet data based on packet data received from the source in a network element, and

means for limiting packet data communication resources provided by the network element for a communications device in response to determining anomalous behaviour of the source, the communication device being a destination of at least part of the packet data based on which the anomalous behaviour of the source is determined or the communications device being the source,

wherein the communications system is configured to provide transmission of packet data for the communications device using the limited transmission resources.

A further aspect of the invention provides network element for a communication system supporting at least packet data transfer, comprising

means for determining anomalous behaviour of a source of packet data based on packet data received from the source in the network element, and

means for deciding to limit packet data transmission resources provided to a communications device by at least the network element in response to determining anomalous behaviour of the source, the communication device being a destination of at least part of the packet data based on which the anomalous behaviour of the source is determined or the communications device being the source.

An aspect of the invention provides a network element for a communication system supporting at least packet data transfer, comprising

means for determining anomalous behaviour of a source of packet data based on packet data received from the source in a further network element, and

means for deciding to limit packet data transmission resources provided to a communications device by at least the further network element in response to determining anomalous behaviour of the source, the communication device being a destination of at least part of the packet data based on which the anomalous behaviour of the source is determined or the communications device being the source.

A further aspect of the invention provides a computer program comprising program instructions for causing a data processing system comprising at least one processor to perform the steps of:

determining anomalous behaviour of a source of packet data based on packet data received from the source in a network element, and

deciding to limit packet data transmission resources provided to a communications device by at least the network element in response to determining anomalous behaviour of the source, the communication device being a destination of at least part of the packet data based on which the anomalous behaviour of the source is determined or the communications device being the source.

An aspect of the invention provides a communication system supporting at least packet data transfer, configured to

receive packet data from a source,

determine anomalous behaviour of the source based on packet data received from the source in a network element, and

limit packet data transmission resources for a communications device in response to determining anomalous behaviour of the source, the communication device being a destination of at least part of the packet data based on which the anomalous behaviour of the source is determined or the communications device being the source,

wherein the communications system is configured to provide transmission of packet data for the communications device using the limited transmission resources.

A further aspect of the invention provides a network element for a communication system supporting at least packet data transfer, configured to

determine anomalous behaviour of a source of packet data based on packet data received from the source in the network element, and

decide to limit packet data transmission resources provided to a communications device by at least the network element in response to determining anomalous behaviour of the source, the communication device being a destination of at least part of the packet data based on which the anomalous behaviour of the source is determined or the communications device being the source.

Another aspect of the invention provides a network element for a communication system supporting at least packet data transfer, configured to

determine anomalous behaviour of a source of packet data based on packet data received from the source in a further network element, and

decide to limit packet data transmission resources provided to a communications device by at least the further network element in response to determining anomalous behaviour of the source, the communication device being a destination of at least part of the packet data based on which the anomalous behaviour of the source is determined or the communications device being the source.

An aspect of the invention provides a method for processing packet data in a communication system supporting at least packet data transfer, the method comprising

determining that a communications device malfunctioning based on packet data received from the communications device,

limiting data transmission resources for use by packet data from the communications device in response to determining that the terminal is malfunctioning,

providing transmission of packet data for the communications device in the communications system using the limited transmission resources, and

blocking in the communication system access to a set of services from the communications device.

A further aspect of the invention provides a communication system supporting at least packet data transfer, comprising

means for receiving packet data from a communications device,

means for determining that the communications device is malfunctioning based on received packet data from the communications device,

means for limiting data transmission resources for use by packet data from the communications device in response to determining that the communications device is malfunctioning, and

means for blocking in the communication system access to a set of services from the communications device,

wherein the communications system is configured to provide transmission of packet data for the communications device using the limited transmission resources.

An even further aspect of the invention provides a network element for a communication system supporting at least packet data transfer, comprising

means for triggering limiting of data transmission resources for use by packet data from a communications device in response to determining that the communications device is malfunctioning, and

means for triggering in the communications system blocking of access to a set of services from the communications device in response to determining that the communications device is malfunctioning.

An aspect of the invention provides a computer program comprising program instructions for causing a data processing system comprising at least one processor to perform the steps of:

triggering limiting of data transmission resources for use by packet data from a communications device in response to determining that the communications device is malfunctioning, and

triggering in a communications system blocking of access to a set of services from the communications device in response to determining that the communications device is malfunctioning.

### BRIEF DESCRIPTION OF THE DRAWINGS

Embodiments of the present invention will now be described by way of example only with reference to the accompanying drawings, in which:

FIG. 1 shows schematically one example of a communication system in accordance with prior art;

FIG. 2a shows, as an example, a flowchart of a method in accordance with an embodiment of the invention;

FIG. 2b shows, as a further example, a flowchart of a method in accordance with a further embodiment of the invention;

FIG. 3 shows schematically an example of a communications system in accordance of an embodiment of the invention; and

FIG. 4 shows schematically an example of a further communications system in accordance with an embodiment of the invention.

### DETAILLED DESCRIPTION OF EMBODIMENTS OF THE INVENTION

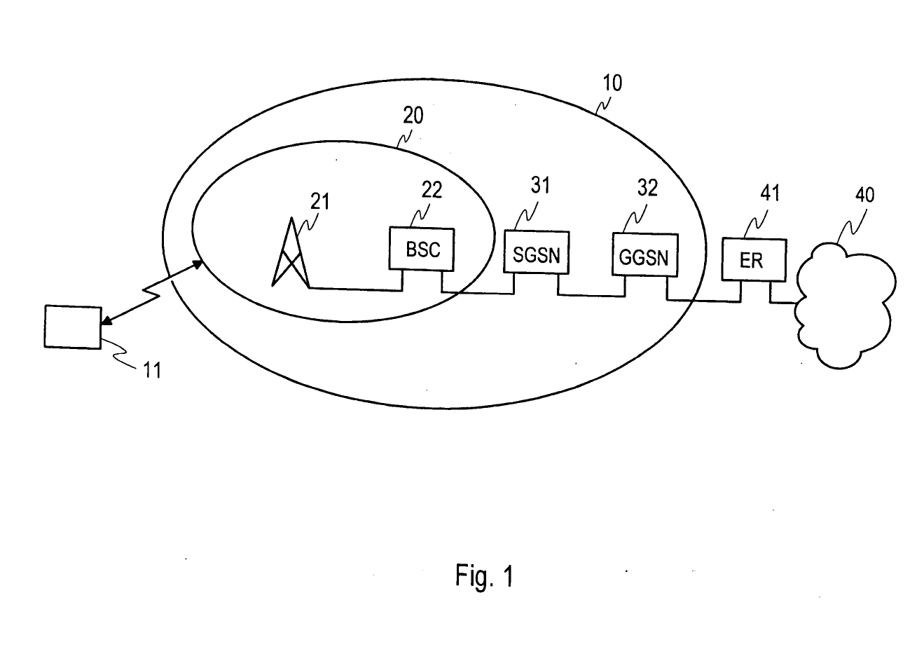

FIG. 1 illustrates schematically, as an example of a cellular system supporting packet-switched services (or, in other words, packet data transfer), a GSM/GPRS communication system 10. Alternatively, the system 10 may be an EDGE/EGPRS network. Only some of the network elements of a GSM/GPRS network are illustrated in FIG. 1. The radio access network 20 comprises a number of base station systems (BSS). Each base station system comprises a base station controller (BSC) 22 and a number of base stations (BS) 21. A mobile station (MS) 11 communicates with a base station 21 over a radio interface. A packet-switched core network of the system GSM/GPRS system comprises a number of GPRS Supporting Nodes (GSN) 31. Each mobile station registered for packet-switched services has a serving GSN, called SGSN, which is responsible for controlling the packet-switched connections to and from the mobile station. The packet-switched core network is typically connected to further packet-switched networks via a Gateway GSN (GGSN) 32. As FIG. 1 shows, a further packet switched network 40 typically comprises an edge router (ER) 41.

It is appreciated that the names of the network elements in the above paragraph relate to a GSM/GPRS network. In a UMTS network, the transceiver network element 21 is called a Node B, and the control network element 22 is called a radio network controller (RNC). Similar network elements with different names exist also in the CDMA2000 network architecture specified by Third Generation Partnership Project 2 (3GPP2). The terminal 11 is called User Equipment. Furthermore, as the actual device using the packet data communications may be, for example, a laptop computer, in the following reference to a communications device is made instead of a mobile station or user equipment. The communications device may be a single device or it may comprise a terminal of a communication network and a further computing device connected to the terminal. Suspecting that a communications device may be infected with malware covers a terminal possibly infected with malware and/or a further computing device connected to the terminal to be possibly infected with malware. Furthermore, it is possible that a terminal may cause excessive traffic to a communications system due to other malfunctioning than infection by malware. A malfunctioning terminal may, for example, try to establish connections repeatedly.

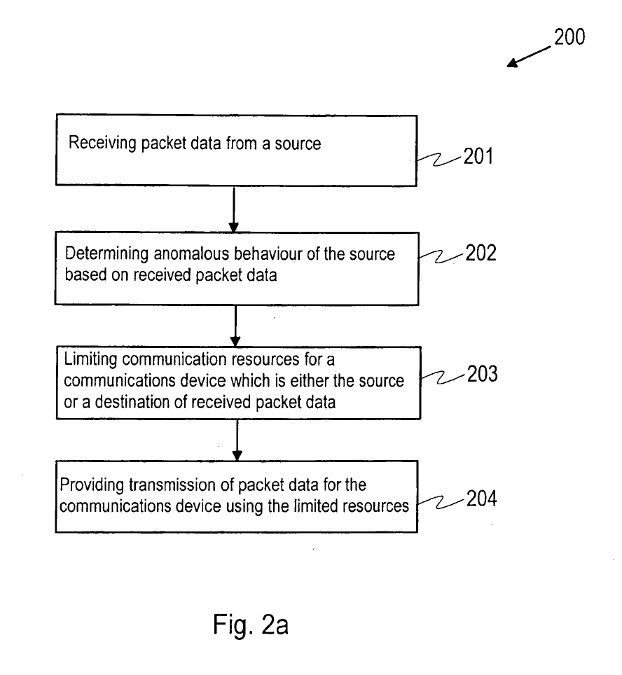

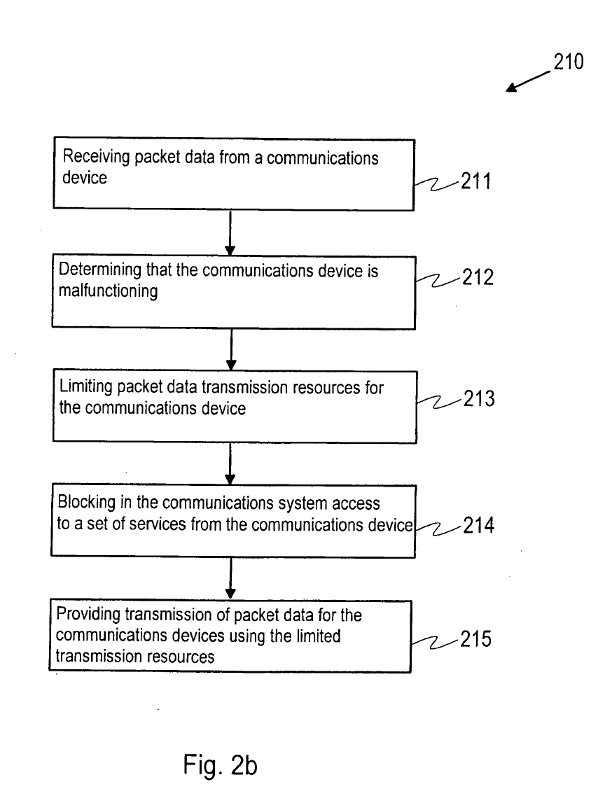

FIG. 2a shows, as an example, a flowchart of a method 200 in accordance with an embodiment of the invention. The method 200 is a method for processing packet data is a communication system supporting at least packet data transfer. In step 201, packet data is received from a source in a network element. Referring to FIG. 1, the source may be a communications device 11 communicating via an access network 20 or the source may be a device sending packet data to the communications device 11. In step 202, it is determined whether the source is subject to anomalous behaviour based on the received packet data. Anomalous behaviour here covers, for example, the source being infected with malware causing the source to transmit excessive amounts of packet data or to repetitively transmit certain data packets, for example, to cause a denial of service attack. Alternatively, the source may be malfunctioning and therefore transmitting excessive amounts of data or repetitive data packet sequences. Some more details about determining that the source of packet data is subject to anomalous behaviour are given below in connection with FIG. 2b.

In step 203, packet data communication resources are limited in the same network element that determined that the source is malfunctioning. The packet data communication resources are limited for a communication device, which is either the source of the packet data in step 201 or which is a destination of at least part of the packet data in step 201. Communication resources are typically limited for a communications device 11 whose all packet data communications pass through the network element receiving packet data from the source in step 201. Typically this means that the communications device 11, whose communication resources are limited, is residing in an access network connected to further networks via the network element receiving packet data from the source in step 201. Limiting data transmission resources may include reducing the bandwidth reserved for a connection or increasing the transmission delay, for example over the radio interface, or lowering quality of service of packet data traffic. As one specific example, the quality of service may be lowered to the lowest quality of service class.

In step 204, packet data transmission is provided for the communications device using the limited resources. Typically packet data transmission resources may be limited in both directions, that is for packet data transmitted by the communications device and for packet data received by the communications device. Alternatively, it is possible to limit only the receipt or transmission or packet data, while packet data transmission in the other direction continues normally. As an example, consider a communications device suspected of being infected with virus and attempting to flood the network or other communications device with excessive amounts of transmitted packets. In this case, the communications device may continue to receive packet data normally, but transmission of packet data is limited to throttle the flooding. The limited transmission capacity allows the communications device to request help for recovering from the situation. Also any possible notification about the limited transmission capacity or suspected presence of malware should reach the communications device, as the communications device continues to receive packet data normally. As a further alternative, it may be useful in some cases to limit packet data transmission resources in the receipt/transmit direction and to completely block the other (transmit/receipt) direction for packet data for the communications device.

FIG. 2b shows, as an example, a flowchart of a method 210 in accordance with a further embodiment of the invention. In this further embodiment, the communications device 11 is the source of the data packets based on which it is determined that the source is subject to anomalous behaviour. The method 210 is a method for processing packet data in a communication system supporting packet data transfer. In step 211, packet data from a communications device is received in the communication system. In step 212, the communication system determines that the communications device is malfunctioning, for example, infected with malware, based on the packet data received from the communications device. For example, an intrusion or anomaly detection component in the communication system may monitor the packet data and identify exceptional behavior based on the known good or bad communication patterns, and/or statistics on earlier communication. The reason for the strange behavior may be an intentional attack by the communication device user, or a virus or Trojan that sends the malicious packets.

It is appreciated that in this description the communication system determining a communications device malfunctioning covers determining with certainty that a communications device is infected by malware or otherwise malfunctioning (for example, by receiving a set of know attack data packets from a communications device) and suspecting that the communications device is infected with malware or otherwise malfunctioning (for example, by receiving an abnormally high amount of packet data from the communications device). The abnormally high data rate may have to be throttled to avoid overloading the network independent if the device is benevolent or malicious (infected).

In step 213, the communication system limits data transmission resources for use by packet data from the communications device in response to determining that the terminal is malfunctioning, for example, infected with malware. Limiting data transmission resources may include reducing the bandwidth reserved for a connection or increasing the transmission delay, for example over the radio interface, or lowering quality of service of packet data traffic. As one specific example, the quality of service may be lowered to the lowest quality of service class. Often the lowest quality of service class is called a background quality of service class. In step 213, the data transmission resources are limited so that the communications device cannot cause excessive load to the communication system.

Quality of service differentiation in a packet forwarding network element in the communications system is typically based on the following. Received packets are classified to QoS classes, and they are assigned to a queue according to the QoS classes. A packet from one of the queues is forwarded, and the selection of the queue from which to forward a packet may be based on a variety of policies. Some examples are round robin, strict priority, weighted priority, pre-emptive methods. Additionally the traffic may be shaped, marked and/or dropped to improve the overall service the system can provide. Shaping means that some packets are intentionally delayed so that they do not disturb the other traffic flows. Marking may change the QoS class, for example the DiffServ code point (DSCP), of selected packets. Dropping removes the packet from the outgoing queue altogether.

Packet classification may be based, for example, on DSCP in the IP packet, PDP context or link layer information, application port number or other higher protocol layer information, or packet length. Bandwidth reserved for a connection is reduced or quality of service class is lowered by shaping, marking and dropping the packets from the malicious device. The packets from the malware infected terminal are typically always mapped to a class and forwarding queue with lower priority. For example, a high priority interactive traffic may be changed to low priority background class, which will be forwarded only when there is no other traffic in any other queue.

In step 214, which is optional, the communication system blocks access to a set of services from the communications device. This blocking of access to a set of services prevents the communications device from using services belonging to this set. This way malware in the communications device cannot access these services. Unless access to services is blocked, the malware in the communications device may have access to any services which the user of the communications device (or the communications device) is authorized to use. This could cause excessive charges to the user, especially if the services were expensive. So, as a specific example, access to expensive services may be blocked. In addition to blocking access to services provided by packet switched data transmission, access to certain circuit-switched services can be blocked. For example, long-distance calls may be blocked.

To block access to a set of services, there typically needs to be a definition of the set of a services to which access is blocked when malware infection is suspected. Alternatively, this set of services may be determined online, for example, based on the price of the services. In general, the communication system contains at least one user information storage, where service subscriptions are stored. When a user (a communications device) tries to access a service, information in the user information storage is checked for ensuring that the user has authorized access to the service. To block access to a set of service, the user information in the user information store may be updated. It is possible to indicate the reason for blocking access in the user information stored in the user information storage.

Depending on the service, the user information storage may be a different storage. For example, for blocking access to a set of IP Multimedia Subsystem (IMS) services, information in a Home Subscriber Server (HSS) needs to be updated. The blocking may also take place in the subscriber profile data in a RADIUS or Diameter server.

It is appreciated that blocking the access to a set of services may cover blocking access from the user of the communications device and/or from the communications device irrespectively of the user.

In step 215, packet data transmission is provided for the communications device using the limited transmission resource. This means that instead of completely inhibiting the communications device from using packet data transfer, data transmission resources for use by the packet data originating from the communications device is limited to a non-zero amount of resources. This way the communications device may still use the communications system for packet data transfer, but the risk of the communications device overloading the communications system with packet data traffic caused by malware is reduced.

Furthermore, if the communications device has functionality to communicate via more than one communications system, embodiments of the invention typically affect only the communications via the communication system where the method 200 or 210 is carried out. Functions relating to services not belonging to the set of blocked services typically also continue to be available. Some examples of these services may be offline Personal Information Management (PIM), and proximity services.

It is furthermore possible to send to the communications device information about limiting data transmission resource for use by packet data traffic and/or information about blocking the access to the set of services. This is applicable for the method 200 and the method 210. The sent information may indicate a reason for limiting the data transmission resources and/or for blocking access to a set of services. Furthermore, this information may indicate how to recover from the situation. This way the user of the communications device becomes aware of these actions. In addition, the user may be informed explicitly about a suspected malware infection and how to recover with a link to help page or phone number of a help desk. Some examples of sending information to the user are short messages (SMS), electronic mail, multimedia messages (MMS), instant messaging (IM), control protocol messages (for example the Session Initiation Protocol (SIP) messages) and voice announcements. Notifications about the limited data transmission resources and/or blocked access to a set of services may be sent repeatedly to the communications device.

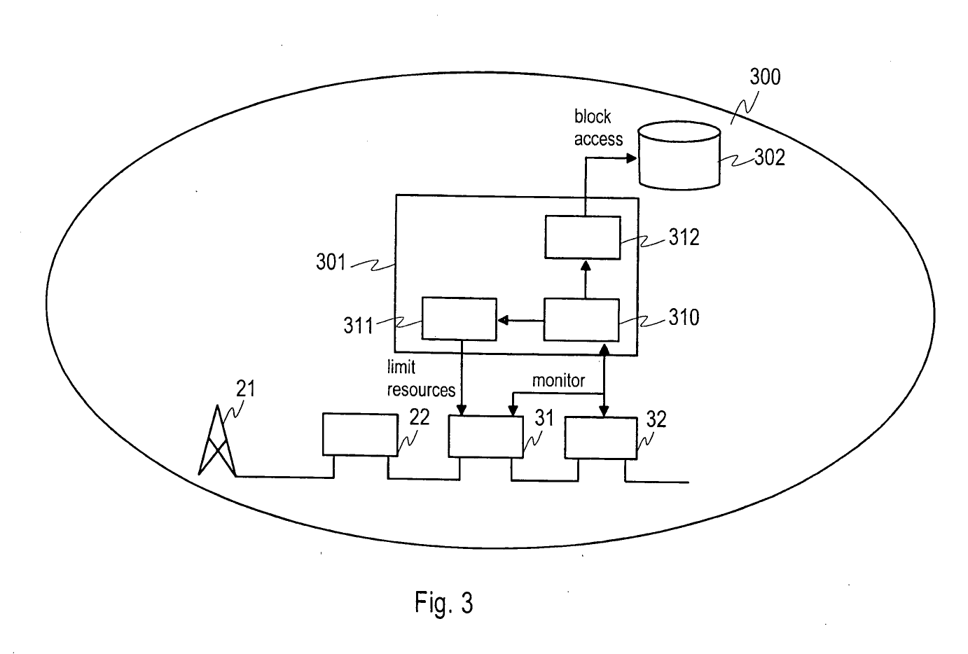

In a communication system in accordance with an embodiment of the invention, the functionality for determining that a source of packet data behaves anomalously based on packet data traffic received from the source, for limiting packet data transmission resources for a communications device in response to determining that the source of received packet data behaves anomalously, and (optionally) for blocking in the communication system access to a set of services from the communications device may be located in one or more than one network element. Typically the functionality of determining that a source of packet data behaves anomalously and the functionality for deciding on limiting packet data transmission resources for a communications device in response to anomalous behaviour of a packet data source reside in a single network element. This network element may be an access network element or a core network element. A further network element may actually provide the packet data transmission resources that are limited in response to the anomalous behaviour of the packet data source. FIG. 3 shows schematically an example of a communications system 300 in accordance of an embodiment of the invention, where there is an Intrusion Detection System (IDS) 301 for determining that a source of packet data, typically a communications device residing in the network monitored by the Intrusion Detection System, is behaving anomalously. The Intrusion Detection System 301 may be configured to detect suspicious activity based on monitoring data packets and to detect high packet transmission load or excessive amount of traffic to expensive services in the communication system in general. The Intrusion Detection System 301 may monitor, for example, the packet data traffic in a SGSN 31, GGSN 32 or in other packet data processing network element (BTS 21 or BSC 22). Additionally the IDS may monitor the actual end user services and packet flows in IP multimedia system (IMS), application servers (AS) or MMS.

When determining that a source of packet data is behaving anomalously, for example the source is (potentially) infected with malware, the Intrusion Detection System 301 may inform a SGSN 31 (or other network element) responsible for controlling packet data transmission resources and a user information storage 302 accordingly. The network element responsible for controlling packet data transmission resources may then limit the packet transmission resources allocated for the communications device. The user information storage 302, in turn, may be configured to block access to a set of services from the communications device. As an alternative, the Intrusion Detection System 301 may directly send a command to block access to a set of services from the communications device to the user information storage 302.

The Intrusion Detection System 301 in FIG. 3, or other network element implementing an embodiment of the present invention, contains functionality 310 for determining anomalous behaviour of a source of packet data based on packet data received from the source and functionality 311 for deciding to limit packet data transmission resources provided to a communications device in response to determining anomalous behaviour of the source. The communication device is either a destination of at least part of the packet data based on which the anomalous behaviour of the source is determined, or the communications device is the source of received packet data itself. The Intrusion Detection System 301 or other network element may further comprise functionality 312 for deciding to block in the communications system access to a set of services from the communications device. The functionality 310, 311, 312 is typically implemented as software, for example as a software update for the network element or Intrusion Detection System.

It is appreciated that, alternatively to providing the Intrusion Detection System 301 as a separate network element, the Intrusion Detection System 301 may be integrated with a network element processing packet data. A network element processing packet data and furthermore containing functionality 310 for determining that a source of packet data is subject to anomalous behaviour and functionality 311 for deciding on limiting packet data communication resources of a communications device in accordance with embodiments of the present invention may be, for example, a radio resource controlling network element 22, a SGSN 31 or a GGSN 32. Alternatively, the network element may be a router connecting the network where the communications device is residing to further networks. This router is often called an edge router.

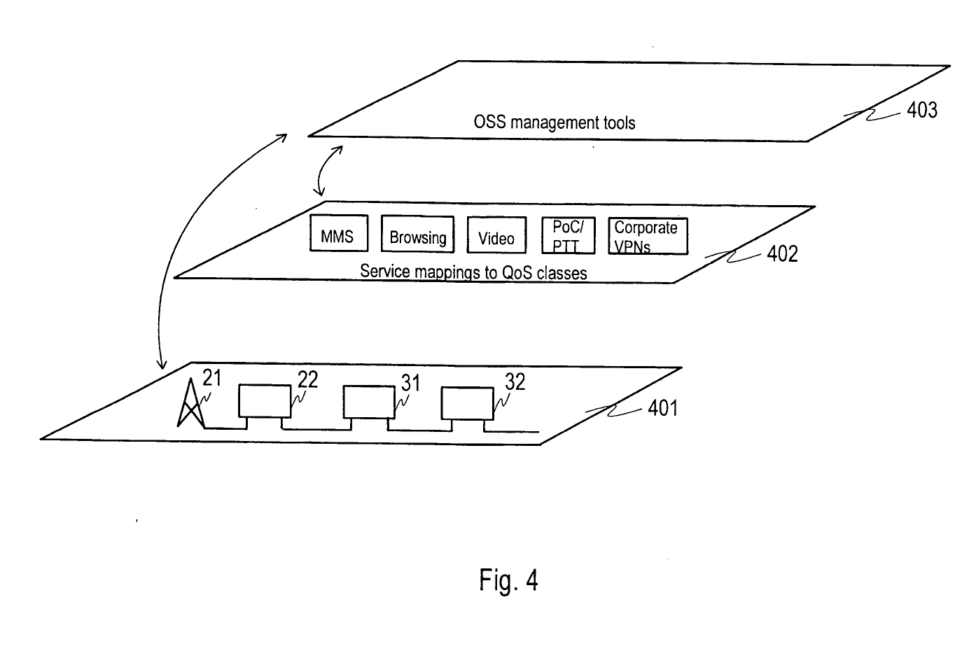

FIG. 4 shows schematically an example of a further communications system in accordance with an embodiment of the invention. In FIG. 4, different quality of service (QoS) differentiation layers are shown. The QoS Differentiation User Plane Enforcement Layer 401 typically treats traffic differently per pipe (packet data protocol context), but this layer 401 is not aware of traffic inside the pipes. The QoS Differentiation Control Plane Enforcement Layer 402 typically controls service mapping to QoS classes, in other words, for example, to priorities, bit rates and/or guaranteed bit rates. FIG. 4 lists the following services as examples: multimedia messaging (MMS), browsing, video (and other streaming services), push-to-talk (PTT) and push-to-talk over cellular (PoC), and corporate virtual private networks (VPN). The QoS Differentiation Management Layer 403 includes Operations Support System (OSS) tools to manage the whole communication system. An intrusion detection system typically controls both the QoS classes on the layer 401 and service blocking on the layer 402.

In principle Intrusion Detection System and communication capability control of communications devices can be located in any QoS aware network element (for example, in RNC, SGSN or GGSN) or in one/some of the network/performance management servers in OSS. A good alternative is to have IDS as an out-of-box server beside the GGSN and trigger the lowered QoS from there or the forthcoming IP session controller (IPSC).

As an example of a use case, consider a situation where several malware infected communications devices start sending IP packets in a cellular communications system over a conversational class channel at a 384 kbit/s rate. Non-infected communications devices accessing the cellular communications system suffer from increased packet delay since the priority queues in the network elements and routers become congested. Also the connection admission control (CAC) may refuse to establish new high priority channels since it has detected the excessive load due to traffic caused by malware. The intrusion detection system in the communications system alarms about the suspicious activity and the high load. The alarm triggers decrease in the infected communications devices' QoS to a background QoS class (For example, best effort with 32 kbit/s). The communication system informs the infected communications devices about the situation and what actions should be taken (virus scan, help desk etc.) As a result of decreasing the QoS of the infected communications device, the non-infected communication devices experience QoS improvement as the congestion eases. CAC typically detects free capacity to serve new requests. The infected communications devices can continue communication, for example, using messaging with the lower QoS to recover from the malware infection.

It is appreciated that the term communications device refers here to any communications device capable of communicating via a communications system. Examples of communications devices are user equipment, mobile telephones, mobile stations, personal digital assistants, laptop computers and the like. Furthermore, a communications device need not be a device directly used by human users.

It is appreciated that embodiments of the invention may typically be implemented as software. The computer programs may be embodied on computer readable medium, stored in the memory of a computer, or carried on a signal.

Although preferred embodiments of the apparatus and method embodying the present invention have been illustrated in the accompanying drawings and described in the foregoing detailed description, it will be understood that the invention is not limited to the embodiments disclosed, but is capable of numerous rearrangements, modifications and substitutions without departing from the spirit of the invention as set forth and defined by the following claims.

1. A method for processing packet data in a communication system supporting at least packet data transfer, the method comprising
determining anomalous behaviour of a source of packet data based on the packet data received in a network element;
limiting packet data communication resources provided by the network element for a communications device in response to determining the anomalous behaviour of the source, the communication device being a destination of at least part of the packet data based on which the anomalous behaviour of the source is determined or the communications device being the source; and
providing transmission of the packet data for the communications device in the communications system using the limited packet data communication resources.

2. A method as defined in claim 1, comprising lowering a quality of service of the packet data relating to the communications device.

3. A method as defined in claim 1, comprising lowering a bandwidth for the packet data relating to the communications device.

4. A method as defined in claim 1, comprising increasing a delay for the packet data relating to the communications device.

5. A method as defined in claim 1, comprising sending to the communications device information about limiting a data transmission resource for use by the packet data.

6. A method as defined in claim 1, comprising blocking, in the communication system, access to a set of services from the communications device

7. A method as defined in claim 6, comprising sending to the communications device information about blocking the access to the set of services.

8. A method as defined in claim 1, wherein the step of providing transmission comprises providing transmission in a cellular communication system

9. A method as defined in claim 1, wherein the step of providing transmission comprises providing transmission of the packet data for a terminal of the cellular network.

10. A method as defined in claim 1, wherein the communications system supports circuit-switched data transfer and the circuit-switched data transfer for the communications device is maintained.

11. A method as defined in claim 1, wherein the communications device is capable of transmitting data via a further communications system and data transmission relating to the communications device is maintained in said further communications system.

12. A method as defined in claim 1, where the anomalous behaviour of the source comprises the source being infected with malware or a malfunctioning of the source.

13. A communication system supporting at least packet data transfer, comprising:
means for receiving packet data;
means for determining anomalous behaviour of a source of the packet data based on the packet data received from the source in a network element; and
means for limiting packet data communication resources provided by the network element for a communications device in response to determining anomalous behaviour of the source, the communication device being a destination of at least part of the packet data based on which the anomalous behaviour of the source is determined or the communications device being the source,
wherein the communications system is configured to provide transmission of the packet data for the communications device using the limited packet data communication resources.

14. A communication system as defined in claim 13, comprising means for blocking, in the communications system, access to a set of services from the communications device.

15. A network element for a communication system supporting at least packet data transfer, comprising:
means for determining anomalous behaviour of a source of packet data based on the packet data received from the source in the network element, and
means for deciding to limit packet data transmission resources provided to a communications device by at least the network element in response to determining anomalous behaviour of the source, the communication device being a destination of at least part of the packet data based on which the anomalous behaviour of the source is determined or the communications device being the source.

16. A network element as defined in claim 15, comprising means for deciding to block, in the communications system, access to a set of services from the communications device.

17. A network element for a communication system supporting at least packet data transfer, comprising:
means for determining anomalous behaviour of a source of packet data based on the packet data received from the source in a further network element; and
means for deciding to limit packet data transmission resources provided to a communications device by at least the further network element in response to determining anomalous behaviour of the source, the communication device being a destination of at least part of the packet data based on which the anomalous behaviour of the source is determined or the communications device being the source.

18. A network element as defined in claim 17, comprising means for deciding to block, in the communications system, access to a set of services from the communications device.

19. A computer program, embodied on a computer-readable medium, comprising program instructions for causing a data processing system to perform the steps of:
determining anomalous behaviour of a source of packet data based on the packet data received from the source in a network element; and
deciding to limit packet data transmission resources provided to a communications device by at least the network element in response to determining anomalous behaviour of the source, the communication device being a destination of at least part of the packet data based on which the anomalous behaviour of the source is determined or the communications device being the source.

20. A communication system supporting at least packet data transfer, configured to:
receive packet data from a source;
determine anomalous behaviour of the source based on the packet data received from the source in a network element; and
limit packet data transmission resources for a communications device in response to determining anomalous behaviour of the source, the communication device being a destination of at least part of the packet data based on which the anomalous behaviour of the source is determined or the communications device being the source,
wherein the communications system is configured to provide transmission of packet data for the communications device using the limited transmission resources.

21. A network element for a communication system supporting at least packet data transfer, configured to:
determine anomalous behaviour of a source of packet data based on the packet data received from the source in the network element; and
decide to limit packet data transmission resources provided to a communications device by at least the network element in response to determining anomalous behaviour of the source, the communication device being a destination of at least part of the packet data based on which the anomalous behaviour of the source is determined or the communications device being the source.

22. A network element for a communication system supporting at least packet data transfer, configured to:
determine anomalous behaviour of a source of packet data based on the packet data received from the source in a further network element; and
decide to limit packet data transmission resources provided to a communications device by at least the further network element in response to determining anomalous behaviour of the source, the communication device being a destination of at least part of the packet data based on which the anomalous behaviour of the source is determined or the communications device being the source.

23. A method for processing packet data in a communication system supporting at least packet data transfer, the method comprising:
determining whether a communications device is malfunctioning based on packet data received from the communications device;
limiting data transmission resources for use by the packet data from the communications device in response to determining that the communications device is malfunctioning;
providing transmission of the packet data for the communications device in the communications system using the limited data transmission resources; and
blocking, in the communication system, access to a set of services from the communications device.

24. A communication system supporting at least packet data transfer, comprising:
means for receiving packet data from a communications device;
means for determining whether the communications device is malfunctioning based on the received packet data from the communications device;
means for limiting data transmission resources for use by the packet data from the communications device in response to determining that the communications device is malfunctioning; and
means for blocking, in the communication system, access to a set of services from the communications device,
wherein the communications system is configured to provide transmission of packet data for the communications device using the limited transmission resources.

25. A network element for a communication system supporting at least packet data transfer, comprising:
means for triggering a limiting of data transmission resources for use by packet data from a communications device in response to determining that the communications device is malfunctioning; and
means for triggering in the communications system a blocking of access to a set of services from the communications device in response to determining that the communications device is malfunctioning.

26. A network element as defined in claim 25, comprising means for determining that a communications device is malfunctioning based on the packet data received from the communications device.

27. A computer program, embodied on a computer-readable medium, comprising program instructions for causing a data processing system to perform the steps of:
triggering a limiting of data transmission resources for use by packet data from a communications device in response to determining that the communications device is malfunctioning, and
triggering in a communications system a blocking of access to a set of services from the communications device in response to determining that the communications device is malfunctioning.
